(19) United States
(12) Patent Application Publication
(10) Pub. No.: US 2004/0100157 A1
(43) Pub. Date: May 27, 2004

(54) Electric machine end turn connectors

(75) Inventors: Laszlo Bori, Mezokovesd (HU); David Crecelius, Noblesville, IN (US); Chahee Peter Cho, Carmel, IN (US)

Correspondence Address: Russell E. Fowler, II, ICE MILLER, One American Square, Box 82001, Indianapolis, IN, 46282-0002, US

(73) Assignee: Delco Remy America

(21) Appl. No.: 09/790,335

(22) Filed: Feb. 22, 2001

(51) Int. Cl. H02K 1/00; H02K 3/00

(52) U.S. Cl. 310/201; 310/180; 29/606

(57) ABSTRACT

Electric machine end turn connectors are used with an electromagnetic device having a ferromagnetic core with a plurality of core slots. Coils are held within the plurality of core slots. The coils are comprised of a plurality of pins positioned within the plurality of core slots. Each of the plurality of pins includes a main body and two tapered ends. When one of the pins is positioned in one of the core slots, the main body of the pin is held within the core slot and the tapered ends of the pin protrude from the stator slot. The plurality of pins form the working lengths of the coils. Two end caps are positioned upon the ferromagnetic core. Each end cap includes a plurality of jumpers. Each jumper includes a bridge portion and two perpendicular connection channels. Each connection channel includes a slit which runs along the connection channel and terminates in a mouth. A heat shrink material surrounds the connection channels. The two end caps are positioned on opposite sides of the ferromagnetic core such that the tapered ends of the pins protruding from the core slots are received by the connection channels of the plurality of jumpers. The connected pins and jumpers form completed coils. To secure the connection between the pins and jumpers, heat is applied to the heat shrink material surrounding the connection channels, thereby causing the connection channels to tightly grasp the pins.

### BACKGROUND

### 1. FIELD OF THE INVENTION

The present invention relates to a stator coil for an electric motor, and more specifically, it relates to a stator coil which reduces the protrusion of coil windings from the stator in the direction of a center axis of the electric motor.

### 2. BACKGROUND OF THE INVENTION

FIGS. 1A and 1B show a structure of a prior art stator coil for a conventional electric motor. The electric motor is a three phase electric motor which includes a stator 102 having a plurality of slots 104 and a rotor 106 which confronts the stator. In FIGS. 1A and 1B the stator 102 is depicted as a straight line, but in fact, the stator is cylindrical with the stator slots 104 opening toward the center rotor 106. FIG. 1A is a top plan view of the stator coil, and FIG. 1B is a side elevational view of the stator coil as seen from the rotor. Although not shown in FIG. 1A because of the linear depiction of the stator and rotor, the rotor is completely surrounded by the stator slots 104. Windings, also referred to as coils, are wound through the stator slots 104 to create respective phases of the coils. The coils include three coil phases, including coil 108A carrying phase A, coil 108B carrying phase B, and coil 108C carrying phase C. Each of the coils 108A, 108B, and 108C is comprised of a bundle of copper wires. The portion of coil actually within a stator slot is called the “working portion” 110 of the coil, while the portion of coil leading from one slot to the next is called the “crossover portion” or an “end turn” 112 of the coil. The end turns of a coil are not useful to the electric motor, other than to provide electrical connections between the working portions of a coil. In fact, the end turns generate much additional heat for the electric motor, and thus it is desirable to limit the size of the end turns. Furthermore, because the end turns take up valuable space within the electric motor, it is desirable to reduce the size of the end turns to provide for an electric motor of reduced size.

As shown in FIG. 1B, when the coils are wound through the stator slots, the end turns protrude above the surface of the stator. This end turn protrusion occurs because the bundle of copper wires within the coil is relatively rigid and can not be wound with extremely sharp, near right-angle, turns in the crossover portion. Instead, the end turns flow smoothly with wide loops from one stator slot to the next. These looping turns result in a great deal of wasted end turn height above and below the stator slots. The large size of the end turns cause additional heat to be generated by the electric motor. In addition, the extra space required to house the large end turns make it difficult to reduce the size of the electric motor.

Size considerations are a great concern in many modern electric motor applications. For example, modern automobile engine compartments have become increasingly cramped. Large electric motors used as starter motors in the engine compartment only add to the cramped condition. Thus, it would be advantageous for starter motors to be reduced in size to provide for more space in modern electric motor applications.

In addition to the above, conventional stator coils must be wound into the slots of the stator. This process involves complicated and expensive robotic machinery that must thread the wires on the slots of the stator to create the stator coils. Alternatively, individuals on an assembly line must hand wind wires through the stator slots to create the coils. Regardless of the method used, the process of placing coils on the stator windings is a significant cost contributor during construction of the electric motor. Thus, it would be advantageous to provide an electric motor with coils that may be easily placed within the stator slots during production of the electric motor.

For the foregoing reasons there is a need for an electric motor which includes stator coils with reduced profile end turns, thereby reducing the heat generated by the electric motor, and allowing the electric motor to be reduced in size. There is also a need for an electric motor with stator coils that may be easily positioned within the stator slots for ease of manufacture.

### SUMMARY

The present invention is directed to an electromagnetic device having a novel set of windings that satisfies the need for an electric motor with reduced profile end turns which may be easily manufactured. The windings of the present invention have sharp end turns which take up less space than prior art stator windings with large looping end turns. Furthermore, the windings are easily incorporated in the stator slots and allow the stator core to be produced at a significantly reduced cost.

The electromagnetic device comprises a rotor and an opposing stator having a plurality of stator slots facing the rotor. Stator coils are held within the plurality of stator slots. The stator coils are comprised of a plurality of pins positioned within the plurality of stator slots. Each of the plurality of pins includes a main body and two tapered ends. When one of the pins is positioned in one of the stator slots, the main body of the pin is held within the stator slot and the tapered ends of the pin protrude from the stator slot. The plurality of pins form the working lengths of the stator coils.

Two end caps are positioned upon the stator. Each end cap includes a plurality of jumpers and each jumper includes a bridge portion with two perpendicular connection channels. Each connection channel includes a slit which runs along the connection channel and terminates in a mouth. A heat shrink material surrounds the connection channels. The two end caps are positioned on opposite sides of the stator such that the tapered ends of the pins protruding from the stator slots are received by the connection channels of the plurality of jumpers, and the connected pins and jumpers form completed coils. To secure the connection between the pins and jumpers, heat is applied to the heat shrink material surrounding the connection channels. When heat is applied to the heat shrink material, and inward force is placed upon the connection channels. The slit extending along each connection channel allows the diameter of the connection channel to decrease as the inward pressure is applied. As the diameter of the connection channels decrease, each connection channel is secured to the tapered end of the pin inserted into the connection channel.

Thus, the jumpers of the present invention provide for reduced profile end turns. Furthermore, the coil structure is easily assembled upon the stator core by inserting pins into the slots and connecting the pins with jumpers. These and other features, aspects, and advantages of the present invention will become better understood with reference to the following description and appended claims.

### BRIEF DESCRIPTION OF THE DRAWINGS

FIG. 1A shows a top plan view of a prior art stator coil for a conventional electric motor;

FIG. 1B shows a side elevational view of the prior art stator coil of FIG. 1;

FIG. 2A shows a side view of pin for use as a working length in the coil of the present invention;

FIG. 2B shows another side view of the pin of FIG. 2A;

FIG. 3A shows a top plan view of a stator with the pins of FIG. 2A inserted into the stator slots;

FIG. 3B shows a side elevational view of the stator of FIG. 3A;

FIG. 4A shows a perspective view of a jumper for use as an end turn of the coil of the present invention;

FIG. 4B shows a perspective view of a jumper having side extensions;

FIG. 5 shows a top plan view of an end cap for use with the stator of FIG. 3A;

FIG. 6 shows a side elevational view of the stator of FIG. 3A connected to the end cap of FIG. 5;

FIG. 7 shows a cross-sectional view of a connection between the pin of FIG. 2A and the jumper of FIG. 4;

FIGS. 8A and 8B show an alternative embodiment of pins for use with the coil of the present invention;

FIG. 9A shows a plan view of an exemplary arrangement of jumpers within the end cap;

FIG. 9B shows a side view of the exemplary arrangement of jumpers of FIG. 9A along lines B-B;

FIG. 9C shows a side cross-sectional view of the exemplary arrangement of jumpers of FIG. 9A along lines C-C.

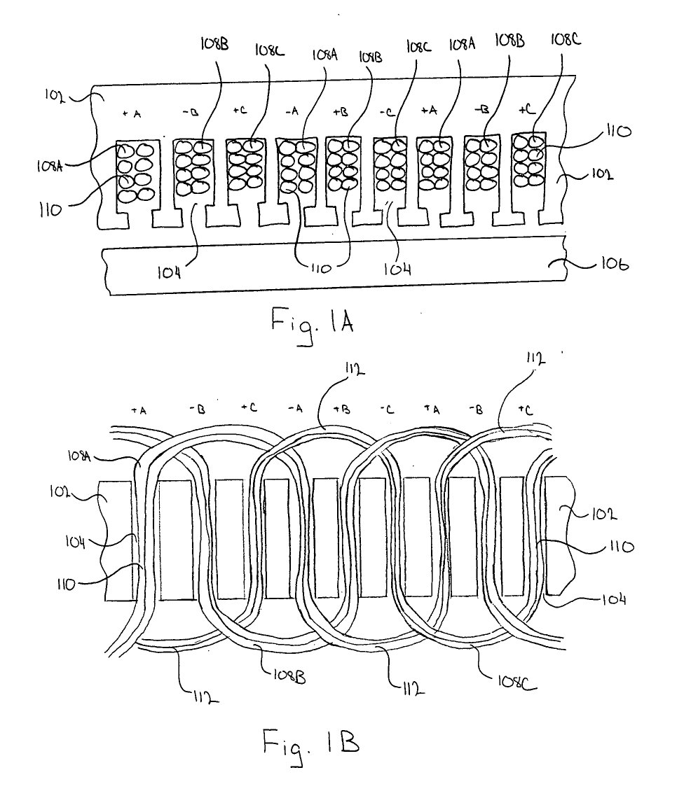

### DESCRIPTION

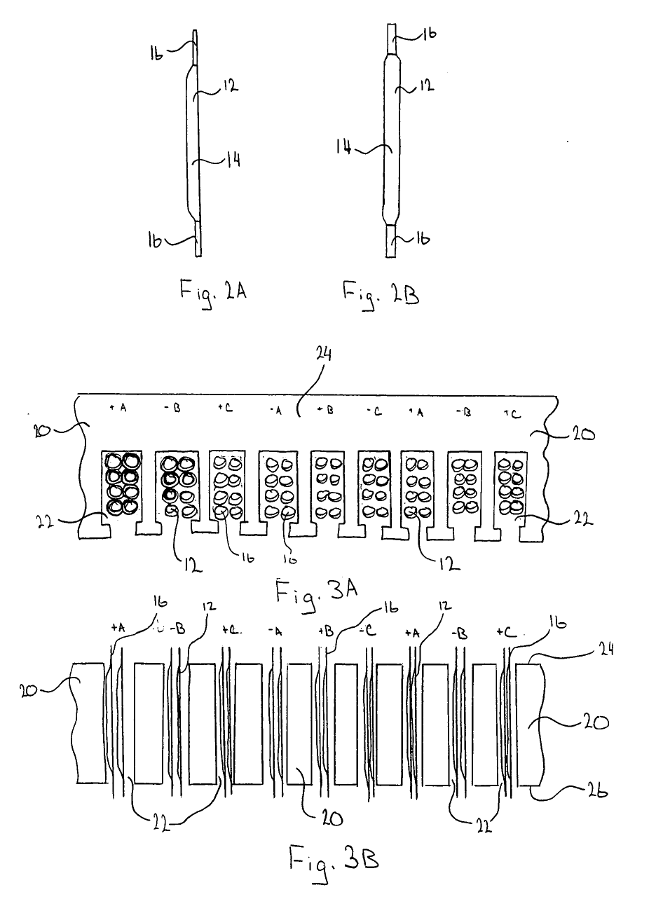

With reference to FIGS. 2-4, the present invention comprises, a ferromagnetic core structure in the form of a stator 20 having a number of slots 22 which hold pins 12. The pins are joined together by jumpers 30. Together, the pins and jumpers form stator coils which provide for electric current flow. The pins 12 are used as the working lengths of the stator coils while the jumpers 30 are used as the coil end turns. The jumpers include ninety (90) degree turns which allow the pins to be connected while minimizing the space required for the end turns.

As shown in FIGS. 2A and 2B, each pin 12 is made of copper and comprises a main body 14 and tapered ends 16. FIG. 2A shows a first side view of a pin 12, while FIG. 2B shows a second side view with the pin 12 rotated ninety (90) degrees. The tapered ends 16 of the pins 12 may be rounded or rectangular in shape. In the embodiment shown herein, the tapered ends are rounded. The main body 14 of each pin is coated with an epoxy material which insulates the pin from other pins. The tapered ends 16 of each pin are bare un-coated copper. By exposing the copper on the tapered ends of the pin, conductive connections may be made between the pins 12 and the jumpers 30. Because the pins 12 are all of similar shape they are easily mass produced. In addition, to assist in the assembly process, multiple pins are generally pre-fabricated into a molded piece designed to fit snugly into one of the stator slots 22. A molded piece is made for each slot 22 of the stator 20. The molded pieces are comprised of a plastic metal or plastic coated iron, and multiple pins 12 are situated in each molded piece. Once a molded piece is cured, the pins in the molded piece are fixed within the molded piece. Thus, multiple pins may easily be inserted into a stator slot and held in place by simply inserting the molded piece into the stator slot.

The pins 12 are inserted lengthwise into the slots 22 of a stator 20, so that the tapered ends 16 of the pins stick out of the slots 22. FIG. 3A shows a top plan view of the stator 20 with the pins 12 positioned within the slots 22. FIG. 3B shows a side elevational view of the stator, as seen from the rotor. In FIGS. 3A and 3B, and other figures herein, the stator 20 is depicted in a linear fashion for convenience of display, but in fact, the stator is cylindrical with the stator slots 104 opening toward a rotor which is concentric with the stator 12, as is standard in the art. Thus, the rotor rotates about a center axis which is also the center axis of the stator. The pins 12 are positioned within the stator slots 22 parallel to this center axis. The stator includes a top face 24 and a bottom face 26. As can be seen from FIG. 3B, the tapered ends of the pins extend from the stator slots 22 above the top face 24 and below the bottom face 26, while the main bodies of the pins are contained within the slots 22.

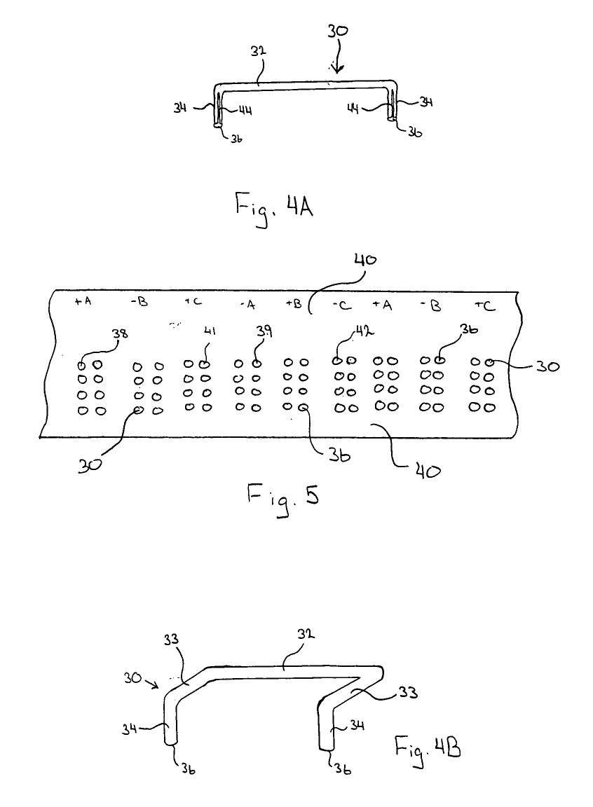

Jumpers 30 are used to connect the tapered ends 16 of the pins 12 extending from the stator 20. A perspective view of an exemplary jumper is shown in FIG. 4. The term end turns is used interchangeably herein to also reference the jumpers. Each jumpers 30 is comprised of copper and includes a bridge portion 32 and connection channels 34 extending perpendicularly from the ends of the bridge portion. Each connection channel 34 includes a mouth 36 for receiving a tapered end 16 of one of the pins 12. In addition, each connection channel 34 includes a slit 44 which extends along the connection channel and down to the mouth 36. When a tapered end of a first pin is placed in one mouth of a jumper and the tapered end of a second pin is placed in the other mouth of the jumper, an electrically conductive path is formed from the first pin, through the jumper, and into the second pin.

The jumpers 30 are embedded in an end cap 40 made of a plastic or similar non-conductive material. FIG. 5 shows the jumpers 30 embedded in one of the end caps 40 with the connection channels 34 showing. The end cap 40 is shown in a linear fashion in FIG. 5, but the end cap 40 is actually cylindrical having a similar diameter to that of the stator. The bridge portions 32 and connection channels 34 of the jumpers are totally embedded in the end cap 40, with only the mouths 36 of the connection channels 34 revealed on the surface of the end cap 40. The mouths 36 emerge from the surface of the end cap 40 so the mouths may be joined with the tapered ends 16 of the pins 12.

FIG. 5 further shows the specific location of the mouths 36 of two different jumpers to provide an example of electric current flow through the end cap. A first jumper embedded in the end cap includes one mouth 38 and another mouth 39. These two mouths 38 and 39 join to pins in the +A and −A phases of the stator slots to form a coil portion for the A phase coil. Similarly, a second jumper includes mouths 41 and 42 for connection to pins which form a coil portion of the C phase coil. Of course, the first jumper and second jumper which help form these coil portions can not interfere with each other, thus, each jumper must be formed to avoid contact with other jumpers. To this end, some jumpers will include longer connection channels than others to place the bridge portion of the jumper in a different plane than surrounding jumpers within the end cap. In addition, the jumpers may include side extensions 33, as shown in FIG. 4B. The side extensions 33 may be used for some jumpers to allow the jumpers to avoid contact with surrounding jumpers.

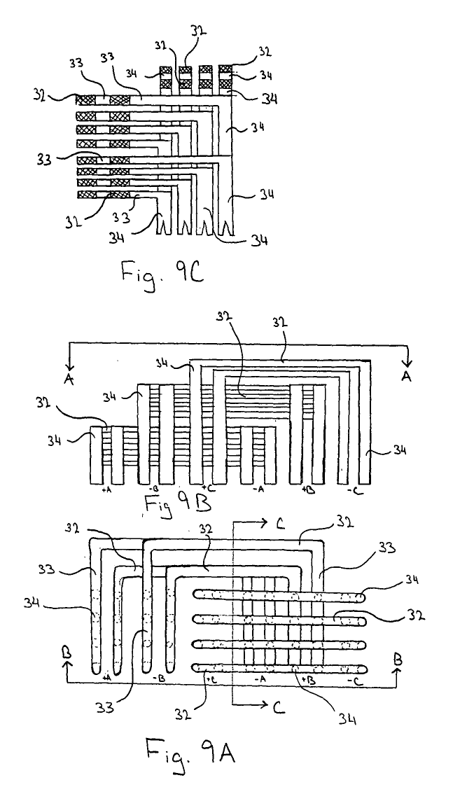

FIGS. 9A-9C provide an exemplary jumper arrangement, as positioned within the end cap 40 of FIG. 5, for connecting the three coil phases 108A, 108B and 108C. FIG. 9A is a top view of the exemplary jumper arrangement. From the top view of FIG. 9A, only some of the bridge portions 32 and side extensions 33 can be seen. Additional bridge portions and side extensions exist directly below the bridge portions and side extensions shown in FIG. 9A. Although the connection channels 34 can not be physically seen from this top view of FIG. 9A, the connection channels 34 extend perpendicular to the side extensions 33 and bridge portions 32, and are indicated by the dotted circles in FIG. 9A.

FIG. 9B is a side view of the exemplary jumper arrangement along lines B-B of FIG. 9A. From the view of FIG. 9B, the connection channels 34 can be seen. The connection channels are of several differing heights. This allows each jumper to avoid interference with other jumpers. Other connection channels exist behind those shown in FIG. 9B. In addition, bridge portions 34 which connect the connection channels can be seen extending behind the connection channels shown in FIG. 9B.

FIG. 9C is a side view of the exemplary jumper arrangement along lines C-C of FIG. 9A. FIG. 9C shows a number of the connection channels 34 of the jumper arrangement along with their associated side extensions 33 and bridge portions 32 (the cross section of the bridge portions are shown in cross-hatching). Additional connection channels exist behind those shown in FIG. 9C. Again, the connection channels 34 are of several differing heights, and the side extensions 33 are of several differing lengths, and this allows the jumpers to avoid contact with each other.

One advantage of the present invention is that the end turns may be arranged in any number of different ways to provide various winding configurations for a single stator. This is possible because the working lengths of the coils are place in the stator slots in a generic fashion and the end turns in the end caps actually connect the pins to each other in a specific winding arrangement. Thus, the pins in one slot may be connected to pins in any other slot to form the desired winding configuration. For example, the end turns 30 in the end cap 40 of FIG. 5 may be arranged to provide either a delta winding configuration or a wye winding configuration when jumpers are attached to the pins. On both delta and wye winding configurations, both concentrated and distributed configurations maybe used. In addition, the number of turns in any given winding may be decreased by shorting pins 16 together within the stator.

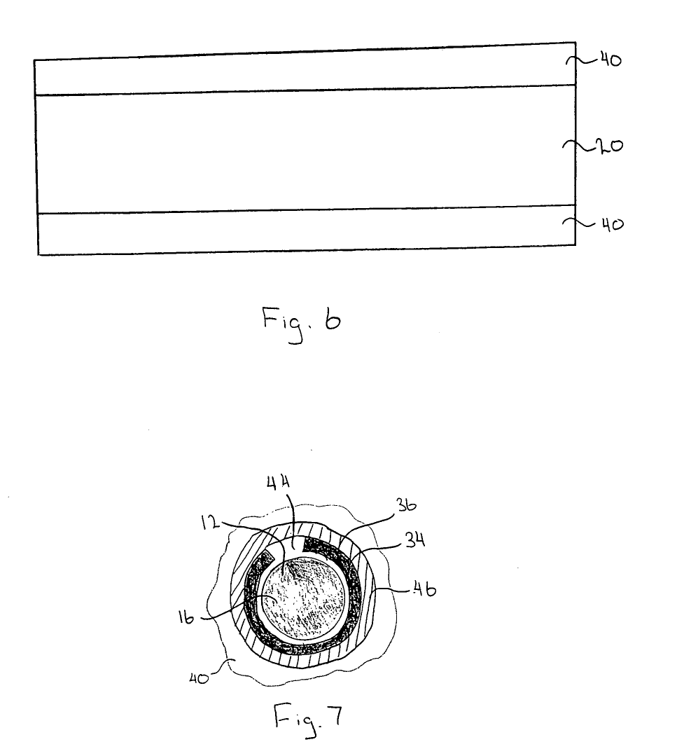

Two end caps 40 with embedded jumpers 30 are provided for connecting the tapered ends of the pins on both the top and bottom sides of the stator 20. This arrangement is shown by the profile view of FIG. 6 in which the end caps 40 sandwich the stator 20. With all of the pins 12 properly positioned within the slots 22 of the stator 20, the end caps 40 are simply positioned upon the top and bottom sides of the stator to complete the stator windings. When an end cap 40 is placed on the stator 20, jumpers 30 within the end cap mate with the tapered ends 16 of the pins 12, thereby providing complete electrical paths for the stator windings. The stator windings typically include three coils carrying different current phases, including phase A, phase B and phase C. The pins act as the working lengths of each coil and the jumpers act as the end turns, with the end turns of the coils positioned at right angles to the working lengths.

The jumpers 30 within each end cap 40 are designed to physically connect to the pins 12 in more than one way when an end cap 40 is place on the stator 20. In one embodiment, the mouths 36 of the jumpers 30 may be friction fit over the tapered ends 16 of the pins 12. According to this embodiment, the mouths 36 of the pins 12 are slightly flared and the connection channels 34 are dimensioned slightly smaller than the tapered ends 16 of the pins 12. Thus, when the tapered ends 16 of the pins 12 are forced into the connection channels 34, the slits 44 allow the connection channels to slightly expand such that the connection channels fit snugly against the pins.

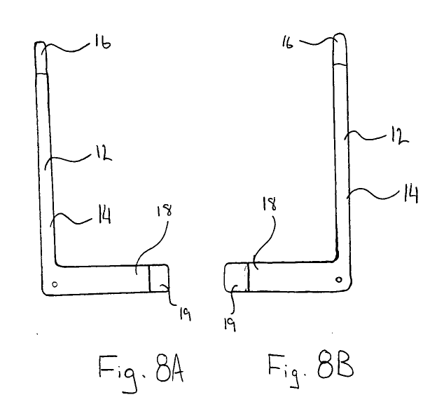

Another embodiment for connecting the jumpers 30 to the pins 12 is shown with reference to FIG. 7, which shows a cross section of the tapered end 16 of a pin 12 inserted through the mouth 36 of a connection channel 34. In this embodiment, each connection channel 34 is surrounded by a heat shrink material 46. In order to position the heat shrink material 46 around the connection channel 34, a cavity must be left open between the connection channel 34 and the end cap 40 when the end cap is molded. After the end cap is molded, the connection channels are in place, and the heat shrink material may be slid into the cavity around the connection channel 34. With the heat shrink material 46 positioned around each connection channel 34 in the end cap, the end cap may be joined to the stator by inserting the tapered ends 16 of the pins 12 into the connection channels 34. Heat is typically provided to the heat shrink material by placing the end cap in an oven. Application of heat to the heat shrink material 46 causes the heat shrink material to shrink and apply inward force to the connection channel 34. As inward force is applied to the connection channel 34, the slit 44 in the connection channel allows the connection channel to shrink in diameter and close around the tapered end 16 of the pin 12, thus securing the jumper 30 to the pin 12.

To further assist in securing the jumpers to the pins, solder paste may be inserted through the mouths 36 and into the connection channels 34 before the pins 16 are inserted into the connection channels. When solder paste is used, placement of the end cap into the oven causes the solder paste to flow within the connection channel 34 and around the pin 16. Then, when the end cap reaches a critical temperature sufficient to collapse the heat shrink material, the heat shrink material forces the connection channel to close around the pin and secure the connection channel against the pin. Once removed from the oven, the solder paste hardens and provides a solid bond between the connection channel and the pin.

Another alternative embodiment of the invention involves the use of L-shaped pins. This embodiment is described with reference to FIGS. 8A and 8B. In this embodiment of the invention, each pin 12 includes a main body 14, a tapered end 12, and a foot 18 extending from the main body at a right angle. The main body 14 of the pin 12 and the foot 18 form an L shape structure. The tapered end of the pin is exposed copper while the main body 14 is coated with an insulating epoxy material along with most of the foot 18. However, a tip 19 of the foot is exposed copper. When two L-shaped pins are joined at their copper tips 19 and welded together, a U-shaped conductor is formed. This U-shaped conductor may then be inserted into the stator with the main body 14 of each L-shaped pin in different stator slots 22. With the U-shaped conductor inserted into the stator in this fashion, the two feet 18 of the L shaped pins act as a coil end turn along one side of the stator. Many U-shaped conductors may be formed and placed into the stator such that the coils are partially complete with end turns formed along the one side of the stator. An end cap having jumpers as described above may then be place on the other side of the stator to complete the stator coils.

Accordingly, the pin and end cap structure of the present invention provides for reduced profile end turns. When the electric motor is used, electric current flows through one pin and into the jumper attached to the pin. The jumper conducts the current to another pin attached to the same jumper. With all jumpers and pins properly attached, coils are formed having reduced profile end turns. The reduced profile end turns minimize the heat generated by the electric motor and also allow the electric motor to be reduced in size. Furthermore, the pin and end cap structure of the present invention provides for easily assembled electric motor coils.

Although the present invention has been described in considerable detail with reference to certain preferred versions thereof, other versions are possible. For example, other alternative methods for connecting the end turns to the pins include welding or soldering the end turns to the pins. Furthermore, in another alternative embodiment of the invention, the jumpers may be used without an end cap. In this embodiment, the jumpers would be placed on the pins one at a time instead of collective placement of the jumpers on the pins with the end cap. Of course, many other alternative embodiments of the invention are possible. Therefore, the spirit and scope of the appended claims should not be limited to the description of the preferred versions contained herein.

What is claimed is:

1. An electric motor comprising:
a. a rotor;
b. a stator having a plurality of stator slots facing the rotor;
c. stator coils held within the plurality of stator slots, the stator coils comprising
i. a plurality of pins positioned within the stator slots, each of the plurality of pins having at least one end protruding from one of the plurality of stator slots;
ii. at least one end cap positioned upon the stator, the at least one end cap including a plurality of jumpers and each jumper including two connection channels with each connection channel terminating in a mouth, the end cap positioned upon the stator such that the ends of the plurality of pins protruding from the stator slots are received by the connection channels of the plurality of jumpers.

2. The electric motor of claim 1 wherein each connection channel includes a slit extending along the length of the connection channel to the mouth.

3. The electric motor of claim 2 wherein each jumper further includes a heat shrink material positioned around each connection channel.

4. The electric motor of claim 1 wherein each of the plurality of pins includes a main body and two tapered ends, the main body held within one of the plurality of stator slots and the tapered ends protruding from the one of the plurality of stator slots.

5. The electric motor of claim 1 wherein the stator includes a top face and a bottom face and the at least one end cap includes a first end cap positioned upon the top face and a second end cap positioned upon the bottom face.

6. A coil structure for use with an electro-mechanical device, the electro-mechanical device including a ferromagnetic core having a plurality of core slots for receiving the coil structure, the coil structure comprising:
a. a plurality of pins positioned within the core slots, each of the plurality of pins having at least one end protruding from one of the plurality of core slots;
b. a plurality of jumpers extending between the ends of the plurality of pins, each of the plurality of jumpers including a bridge portion and two connection channels with each connection channel terminating in a mouth, the plurality of jumpers extending between the ends of the plurality of pins such that the ends of the plurality of pins are received by the connection channels of the plurality of jumpers.

7. The coil structure of claim 6 wherein each connection channel includes a slit extending along the length of the connection channel to the mouth.

8. The coil structure of claim 7 wherein each jumper further includes a heat shrink material positioned around each connection channel.

9. The coil structure of claim 6 wherein each of the plurality of pins includes a main body and two tapered ends, the main body held within one of the plurality of core slots and the tapered ends protruding from the one of the plurality of core slots.

10. The coil structure of claim 6 wherein the plurality of jumpers are contained within at least one end cap.

11. The coil structure of claim 10 wherein the plurality of core slots include a top face and a bottom face and the at least one end cap includes a first end cap positioned upon the top face of the core slots and a second end cap positioned upon the bottom face of the core slots.

12. The coil structure of claim 6 wherein each of the plurality of pins includes a main body having a tapered end at one end and a foot at the other end.

13. The coil structure of claim 12 wherein the foot of each of the plurality of pins is connected to the foot of another of the plurality of pins.

14. A method of winding a coil through a plurality of slots of a ferromagnetic core structure in an electro-mechanical device, the method comprising the steps of:
a. providing a plurality of pins;
b. inserting the plurality of pins into the plurality of slots such that each of the plurality of pins has at least one end protruding from one of the plurality of slots;
c. providing at least one end cap including a plurality of jumpers having two connection channels, each connection channel terminating in a mouth;
d. positioning the at least one end cap upon the plurality of slots such that the ends of the plurality of pins protruding from the plurality of slots are received by the connection channels of the plurality of jumpers.

15. The method of claim 14 wherein solder paste is inserted into each connection channel before the at least one end cap is positioned upon the plurality of slots.

16. The method of claim 14 wherein each connection channel includes a slit extending along the length of the connection channel to the mouth.

17. The method of claim 16 wherein each jumper further includes a heat shrink material positioned around each connection channel, and further including the step of applying heat to the heat shrink material after the at least one end cap is positioned upon the plurality of slots.

18. The method of claim 15 wherein each of the plurality of pins includes a main body and two tapered ends, such that the main body is held within one of the plurality of slots and the two tapered ends respectively protrude from opposite ends of the one of the plurality of slots.

19. The coil structure of claim 16 wherein the plurality of slots include a top face and a bottom face and the at least one end cap includes a first end cap and a second end cap such that the step of positioning the at least one end cap on the plurality of slots includes positioning the first end cap on the top face and the second end cap on the bottom face.
